(19) United States
(12) Patent Application Publication
(10) Pub. No.: US 2003/0201191 A1
(43) Pub. Date: Oct. 30, 2003

(54) Electrochemical method for direct organic additives analysis in copper baths

(75) Inventors: Nicolay Kovarsky, Sunnyvale, CA (US); Zhi-Wen Sun, San Jose, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 10/135,485

(22) Filed: Apr. 29, 2002

(51) Int. Cl. G01N 27/48

(52) U.S. Cl. 205/775; 204/434

(57) ABSTRACT

A voltammetric method for measuring the concentration of additives in a plating solution. The method generally includes providing the plating solution, including an unknown concentration of an additive to be measured, cycling an inert working electrode potential to alternately deposit and strip metal from the working electrode surface in the plating solution, wherein the metal deposition step includes a constant voltage plateau at a plateau potential sufficient to eliminate the interference of additives in the plating solution other than the additive to be measured. The method further includes determining a profile of the anodic current resulting from the applied working electrode potential as a function of time and determining a stripping peak area. The method may further include determining the concentration of the additive to be measured by the ratio of the stripping peak area from the profile to a stripping peak area of a base solution not including the additive to be measured.

### BACKGROUND OF THE INVENTION

1. Field of the Invention

Embodiments of the invention generally relate to analysis of plating solutions, and more particularly, to the analysis of additives in plating solutions.

2. Description of the Related Art

Metallization of sub-quarter micron sized features is a foundational technology for present and future generations of integrated circuit manufacturing processes. More particularly, in devices such as ultra large scale integration-type devices, i.e., devices having integrated circuits with more than a million logic gates, the multilevel interconnects that lie at the heart of these devices are generally formed by filling high aspect ratio interconnect features with a conductive material, such as copper or aluminum, for example. Conventionally, deposition techniques such as chemical vapor deposition (CVD) and physical vapor deposition (PVD) have been used to fill interconnect features. However, as interconnect sizes decrease and aspect ratios increase, efficient void-free interconnect feature fill via conventional deposition techniques becomes increasingly difficult. As a result thereof, plating techniques, such as electrochemical plating (ECP) and electroless plating, for example, have emerged as viable processes for filling sub-quarter micron sized high aspect ratio interconnect features in integrated circuit manufacturing processes.

In an ECP process, for example, sub-quarter micron sized high aspect ratio features formed into the surface of a substrate may be efficiently filled with a conductive material, such as copper, for example. ECP plating processes are generally two stage processes, wherein a seed layer is first formed over the surface and features of the substrate, and then the surface and features of the substrate are exposed to a plating solution, while an electrical bias is simultaneously applied between the substrate and an anode positioned within the plating solution. The plating solution is generally rich in ions to be plated onto the surface of the substrate, and therefore, the application of the electrical bias causes these ions to be urged out of the plating solution and to be plated onto the seed layer. Furthermore, the plating solution generally contains organic additives, such as, for example, levelers, suppressors, and accelerators that are configured to increase the efficiency and controllability of the plating process. These additives are generally maintained within narrow tolerances, so that the repeatability and controllability of the plating operation may be maintained and repeated.

Monitoring and/or determining the composition of a plating solution during an ECP process is problematic, as the depletion of certain additives is not necessarily constant over a period of time, nor is it always possible to correlate the plating solution composition with the plating solution use. As such, it is difficult to determine the amount of additives in a plating solution with any degree of accuracy over time, as the level of additives may either decrease or increase during plating, and therefore, the additive concentrations may eventually exceed or fall below the tolerance range for optimal and controllable plating. Conventional ECP systems generally utilize a cyclic voltammetric stripping (CVS) process to determine the organic additive concentrations in the plating solution. In a CVS process, the potential of a working electrode is swept through a voltammetric cycle that includes both a metal plating range and a metal stripping range. The potential of the working electrode is swept through at least two baths of non-plating quality, e.g., in a conditioning step, and an additional bath, e.g., a supporting electrolyte, where the quality or concentration of one of the organic additives therein is unknown. In this process, an integrated or peak current used during the metal stripping range may be correlated with the quality of the non-plating bath. As such, the integrated or peak current may be compared to the correlation of the non-plating bath, and the quality of the unknown plating bath determined therefrom. The amount of metal deposited during the metal plating cycle and then redissolved into the plating bath during the metal stripping cycle generally correlates to the concentration of particular organics, generally brighteners, accelerators, suppressors, or levelers in the plating solution. CVS methods generally observe the current density of the copper ions reduced on an electrode at a predetermined potential, e.g., during a cathodic potential, inasmuch as accelerators or brighteners increase the current density, while suppressors decrease the current density. Therefore, the additive concentration may be determined from the observation.

However, one challenge associated with utilizing CVS for determining the quantity of organics in an ECP solution is that conventional CVS methods cannot be used for direct insitu analysis of additives in plating solutions. Another challenge with conventional CVS methods is that they have a relatively low reproducibility and selectivity to accelerator concentrations in the plating solution. As such, there is a need for a method for measuring additives in a plating solution, wherein the method is not susceptible to the inaccuracies of conventional CVS measurement systems.

### SUMMARY OF THE INVENTION

Embodiments of the invention generally relate to a voltammetric method for measuring the concentration of additives in a plating solution. The method generally includes providing a plating solution, including an unknown concentration of an additive to be measured therein, and cycling an inert working electrode potential to alternately deposit and strip metal from a working electrode surface in the plating solution. The metal deposition step generally includes a constant voltage plateau at a plateau potential sufficient to eliminate the interference of additives in the plating solution other than the additive to be measured. The method further includes determining a profile of the anodic current resulting from the applied working electrode potential as a function of time and determining a stripping peak area. The concentration of the additive to be measured is then determined from the ratio of the stripping peak area of the profile to a stripping peak area of a base solution not including the additive to be measured.

Embodiments of the invention further provide a voltammetric method for measuring the concentration of an accelerator in a plating solution. The method generally includes providing the plating solution having an unknown concentration of an accelerator to be measured therein, and cycling an inert working electrode potential through a metal deposition step and a metal stripping step, wherein the metal deposition step includes a constant voltage plateau at a plateau potential between about −0.25 V and about −0.4 V. The method further includes determining a profile of an anodic current resulting from the working electrode potential as a function of time and determining a stripping peak area, and determining the concentration of the accelerator by a ratio of the stripping peak area from the profile of the anodic current to a stripping peak area of a base solution.

Embodiments of the invention additionally provide a voltammetric method for measuring the concentration of an accelerator in a copper plating solution. The method generally includes cycling an inert working electrode potential through a metal deposition step and a metal stripping step, wherein the metal deposition step includes pulsing to a constant voltage potential from about −0.25 V to about −0.4 V from an open circuit potential and pulsing back to the open circuit potential before the metal stripping step, which comprises an anodic linear sweep. The method may further include determining a profile of the anodic current resulting from the applied working electrode potential as a function of time, determining a stripping peak area, and determining the concentration of the accelerator by a ratio of the stripping peak area from the profile to a stripping peak area of a base solution not including the additive to be measured.

Embodiments of the invention further provide a voltammetric method for directly measuring the concentration of additives in a plating solution. The method generally includes cycling an inert working electrode potential through a metal deposition step and a metal stripping step, wherein the metal deposition step includes scanning to a constant voltage plateau at a potential sufficient to eliminate the interference of additives in the plating solution other than the additive to be measured and scanning back to the open circuit potential from the plateau potential before the metal stripping step. The method may further include determining a profile of the anodic current response resulting from the applied potential as a function of time, and determining the concentration of the additive to be measured by the current response when the plateau potential is at a potential sufficient to eliminate the interference of additives in the plating solution other than the additive to be measured.

Embodiments of the invention further provide a voltammetric method for directly measuring the concentration of an accelerator in a plating solution. The method generally includes providing the plating solution to an electroplating cell, wherein the electroplating solution includes copper sulfate in a ratio to an optimum copper sulfate concentration of between about 0.8 and about 1.2, and sulfuric acid in a ratio to an optimum sulfuric acid concentration of between about 0.8 to about 1.2. The method further includes cycling an inert working electrode potential through a metal deposition step and a metal stripping step including an anodic linear sweep, wherein the metal deposition step includes pulsing to a constant voltage plateau at a plateau potential between about −0.25 V and about −0.4 V from an open circuit potential and pulsing back to the open circuit potential from the plateau potential before the metal stripping step, determining a profile of the anodic current response resulting from the applied potential as a function of time, and determining the concentration of the additive to be measured by a constant, k_{c} determined from the current response when the plateau potential is at a potential between about −0.25 V and about −0.4 V.

### BRIEF DESCRIPTION OF THE DRAWINGS

So that the manner in which the above recited features of the present invention can be understood in detail, a more particular description of the invention, briefly summarized above, may be had by reference to the embodiments thereof, which are illustrated in the appended drawings. It is to be noted, however, that the appended drawings illustrate only typical embodiments of this invention, and are therefore, not to be considered limiting of its scope, for the invention may admit to other equally effective embodiments.

FIG. 1 is an exemplary embodiment of a plating system of the invention.

FIG. 2 is a cross section of a plating solution analysis device.

FIG. 3 shows the output of conventional CVS analysis.

FIG. 4 shows the output of an exemplary embodiment of the invention.

FIG. 5 shows the output of an alternative embodiment of the invention.

FIG. 6 shows the output of an alternative embodiment of the invention.

FIG. 7 shows the accelerator concentration measurement as a function of cathodic current versus time.

FIG. 8 show the suppressor concentration measurement as a function of cathodic current versus time.

### DETAILED DESCRIPTION OF THE PREFERRED EMBODIMENT

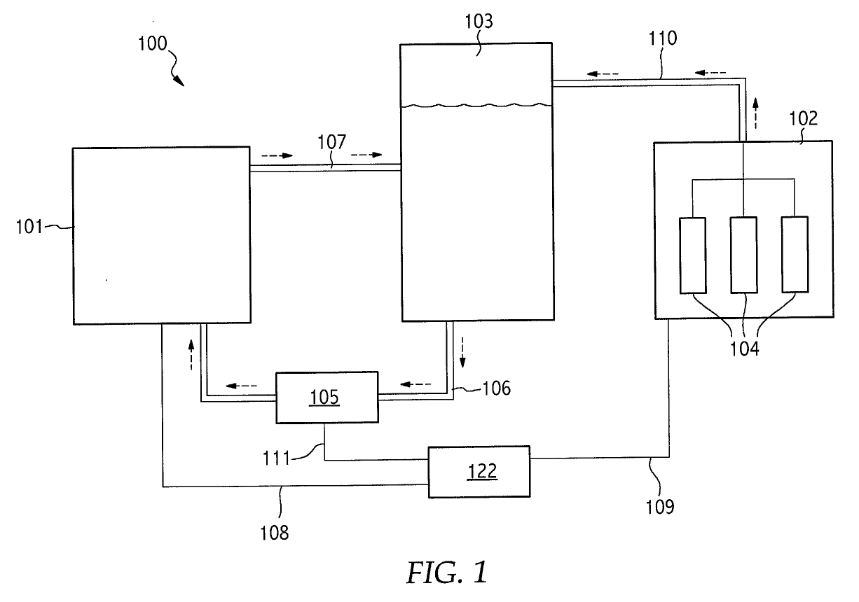

FIG. 1 illustrates an exemplary plating system 100 of the invention. The plating system 100 generally includes a plating cell 101, which may be, for example, an ECP plating cell configured to electrochemically plate copper onto a semiconductor substrate. The plating cell 101 may be selectively in fluid communication with a plating solution tank 103 configured to maintain a large volume of plating solution, approximately 200 liters, for example. The plating solution tank 103 may be configured to supply a plating solution stored therein to the plating cell 101 via a plating solution supply conduit 106. The supply conduit 106 may be in fluid communication with a plating solution analysis device 105 configured to sample a portion of the plating solution flowing therethrough to determine the quantity of various components in the sampled portion of the plating solution. Alternatively, analysis device 105 may be in fluid communication with another fluid source in system 100, such as, for example, tank 103, cell 101, or another element of a plating system capable of supplying a solution to be measured to the device 105. The plating system 100 may further include a chemical cabinet 102 having one or more chemical storage units 104 positioned therein or in fluid communication therewith. The chemical cabinet 102, and in particular, chemical storage units 104, may be selectively in fluid communication with the plating solution tank 103 via a chemical supply conduit 110.

Additionally, the plating system 100 may include a system controller 122, which may be a microprocessor-based controller, for example, configured to control the operation of the respective components of the plating system 100. The system controller 122 may be in electrical communication with the components of the plating cell 101 via an electrical conduit 108, with the components of the plating solution analysis device 105 via an electrical conduit 111, and with the components of chemical cabinet 102 via an electrical conduit 109. As such, the system controller may receive inputs from the various components of plating system 100 and generate control signals that may be transmitted to the respective components of the plating system 100 for controlling the operation thereof. For example, the system controller 122 may be configured to control parameters such as the flow rate of plating solution into the plating cell 101, the timing and quantity of chemicals added to the plating solution by the chemical cabinet 102, and the operational characteristics of the plating cell 101, in accordance with a semiconductor processing recipe, for example.

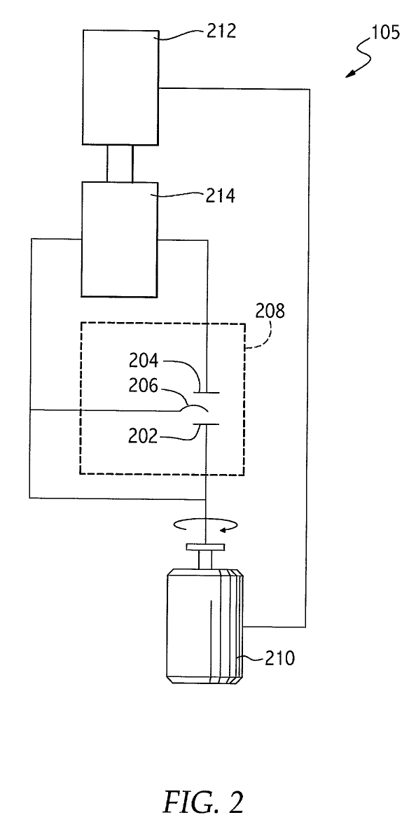

FIG. 2 illustrates a plating solution analysis device 105 useful in practicing the present invention. Three electrodes, a working electrode 202, a counter electrode 204, and a reference electrode 206, are immersed in a cell 208 having plating solution to be measured therein. The counter electrode 204 is selected and designed so as not to be easily polarized in the particular plating solution being evaluated. This is accomplished in part by placing the counter electrode 204 close to the working electrode 202. The working electrode 202 is a suitable metal disk, such as platinum, copper, nickel, chromium, zinc, tin, gold, silver, lead cadmium, solder, glassy carbon, mercury, or stainless steel, for example. The working electrode 202 typically has a flat, polished surface of a small diameter, and may be mounted flush with the end of a cylinder. A small diameter disk, e.g., about 2 mm to about 10 mm, is generally preferred since a larger diameter will result in poor sensitivity due to non-uniform current density across the diameter. Other suitable working electrodes 202 include any electrode that provides a uniform current density and controlled agitation. The reference electrode 206 may, for example, be a saturated Calomel reference electrode (SCE) 206. To establish relative motion between the working electrode 202 and the plating solution, a motor 210 is used to rotate the working electrode 202. Without such motion, the plating solution generally becomes depleted at the surface of the working electrode 202 and the deposition rate obtained does not reflect the correct rate for the plating solution. Other means of obtaining relative motion can be used, such as a pump for moving the plating solution across the face of the working electrode 202.

A computer 212 generally controls an electronic potentiostat 214, which controls the energy input between the working electrode 202 relative to the reference electrode 206. Using a suitable program, specific energy input sequences of the present invention may be applied to the working electrode 202. The output of the device 105 can also be plotted on an X-Y recorder for each step. The following description of embodiments of the invention will be described by reference to the energy input as current and energy output as potential, and will be described by reference to standard acid/copper electroplating solutions. It is possible however to use the method to control other metal solutions such as nickel, chromium, zinc, tin, gold, silver, lead, cadmium, and solder, for example. The working electrode 202 is generally selected or initially plated to match the metal in the plating solution in order to maximize adsorption of the respective additives used in the plating solution.

Embodiments of the invention generally employ copper plating solutions having copper sulfate at a concentration between about 5 g/L and about 100 g/L, an acid at a concentration between about 5 g/L and about 200 g/L, and halide ions, such as chloride, at a concentration between about 10 ppm and about 200 ppm, for example. The acid may include sulfuric acid, phosphoric acid, and/or derivatives thereof. In addition to copper sulfate, the plating solution may include other copper salts, such as copper fluoborate, copper gluconate, copper sulfamate, copper sulfonate, copper pyrophosphate, copper chloride, or copper cyanide, for example. However, embodiments of the invention are not limited to these parameters.

The electroplating solution may further include one or more additives. Additives, which may be, for example, levelers, inhibitors, suppressors, brighteners, accelerators, or other additives. known in the art, are typically organic materials that adsorb onto the surface of the substrate being plated. Useful suppressors typically include polyethers, such as polyethylene glycol, or other polymers, such as polyethylene-polypropylene oxides, which adsorb on the substrate surface, slowing down copper deposition in the adsorbed areas. Useful accelerators typically include sulfides or disulfides, such as bis(3-sulfopropyl) disulfide, which compete with suppressors for adsorption sites, accelerating copper deposition in adsorbed areas. Useful levelers typically include thiadiazole, imidazole, and other nitrogen containing organics. Useful inhibitors typically include sodium benzoate and sodium sulfite, which inhibit the rate of copper deposition on the substrate. During plating, the additives are consumed at the substrate surface, but are being constantly replenished by the plating solution. However, differences in diffusion rates of the various additives result in different surface concentrations at the top and the bottom of the features, thereby setting up different plating rates in the features. Ideally, these plating rates should be higher at the bottom of the feature for bottom-up fill. Thus, an appropriate composition of additives in the plating solution is required to achieve a void-free fill of the features.

The accelerator concentration in the plating solution generally should remain in the low ppm range, e.g., less than 5 ppm, to obtain acceptable deposits. Additive concentrations fluctuate as a result of oxidation at the anode, reduction and inclusion at the cathode and chemical reactions. When the accelerator level is insufficient, the copper deposits are burnt and powdery. Excess accelerator induces brittleness and a nonuniform deposition on the substrate surface. Either excess or insufficient accelerator concentration may cause voids in the features decrease the adhesion and reflectability of the copper deposit. Since the additive concentrations are continually fluctuating within the plating solution, it is necessary to minimize the time between chemical analysis and correction of the additive concentration within the plating solution.

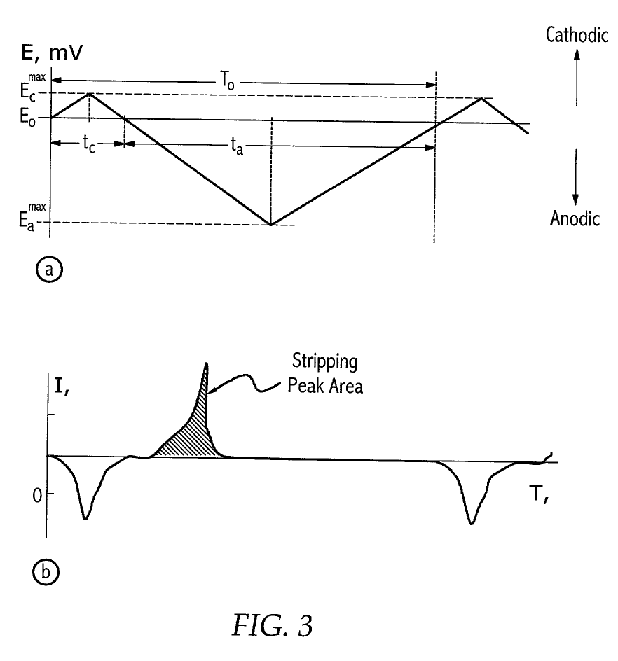

FIG. 3 illustrates a voltage signal for conventional CVS analysis. To better understand aspects of the invention, conventional CVS methods will be explained in more detail below. Conventional CVS methods include cycling the potential of the working electrode 202 at a constant rate in both the cathodic and anodic directions in a plating solution so that a small amount of metal is alternately deposited on the electrode surface and stripped off by anodic dissolution. Conventional CVS includes scanning the potential between the working electrode 202 and the reference electrode 206 from an initial voltage, E₀, in anodic direction until a maximum voltage is attained, E_{c}^{max}, and then back to E₀ in the cathodic direction. As used herein, the term “scan” refers to linearly ramping to a desired potential from a prior potential. In this range, t_{c}, the cathodic deposition of metal proceeds. The potential is generally scanned linearly as a function of time. As a result of linear scanning, the rate of metal deposition is sensitive to the presence and concentration of additives present in the plating solution. Therefore, the amount of electricity spent for metal deposition, Q_{c}, changes depending on the plating solution composition. Selection of the proper scan rate, dE/dt, and E_{c}^{max} help to make Q_{c} more sensitive to the additive that must be analyzed. However, the scan rate is not varied during the measurement, therefore, the scan passes through both accelerator sensitive and non-sensitive potential intervals with the same scan rate.

Conventional systems employ a constant sweep rate, and therefore the area under the stripping peak, i.e., the stripping peak area, is proportional to the average deposition rate for a given cycle. The effects of other bath constituents and changes in the state of the working electrode 202 surface are mitigated by utilizing an internal standard provided by the counter electrode 204 in the same solution or by utilizing a supporting electrolyte that reduces the dependence of Q_{c} on other solution constituents. Conventional CVS selectivity to the additive to be measured is generally relatively low as a result of the linear scan. The deposition current, I, is sensitive to the additive to be measured only in a specific potential range. The specific potential range is generally much narrower than the E₀ to E_{c}^{max} interval. As a result, conventional CVS averages both deposition rates in additive sensitive and non-additive sensitive potential ranges. Therefore, the Q_{c} includes a constant, K, that is sometimes much larger than the difference in Q_{c}, DQ_{c}(C), as shown in the following equations:

Q_{c}(C₁)=K+DQ_{c}(C₁); (1)

where C₁ is the concentration of the additive to be measured at the working electrode 202, K is an equilibrium constant, DQ_{c}(C) is the difference in the electricity spent for metal deposition at an initial time period and a second time period, for example, the time when substantially all of the metal has been stripped.

Q_{c}(C₂)=K+DQ_{c}(C₂); (2)

where C₂ is the concentration of the additive to be measured at the counter electrode 204. Therefore, when K is much larger than DQ_{c}(C), the ratio of concentrations, Q_{c}(C₁)/Q_{c}(C₂), becomes close to one, and therefore insensitive to the concentration difference, DQ_{c}(C).

It has been observed that at relatively low potentials, i.e., between about 0 V and about −0.2 V, the metal deposition rate is sensitive mainly to the suppressor. On the other hand, between about −0.25 V and about −0.4 V the metal deposition rate is sensitive mainly to the accelerator. Therefore, embodiments of the invention contemplate using conventional CVS methods to analyze the suppressor concentration when the potential does not exceed about −0.2 V.

In contrast, the stripping peak area includes information on both the suppressor and accelerator when the potential exceeds −0.2 V. Therefore, the information included on the suppressor should be eliminated to determine the accelerator concentration.

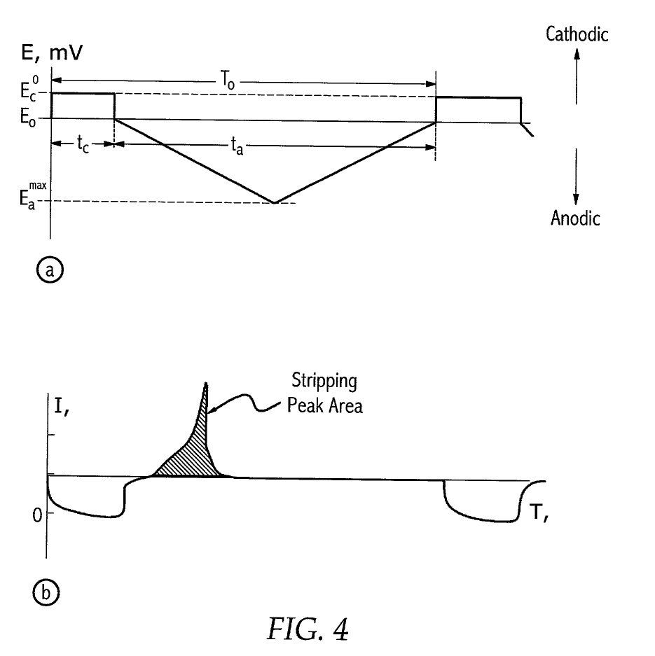

FIGS. 4 to 8 illustrate the output of an exemplary embodiment of the invention eliminating the influence of the suppressor concentration on the accelerator analysis. Embodiments of the invention improve upon conventional methods by pulsing immediately to a potential between about −0.25 V and about −0.4 V from the open circuit potential, i.e., in the cathodic direction. As used herein, the term “pulse” refers to immediately applying a desired potential from a prior potential. The method further includes a plateau in the metal deposition region, t_{c}, where the potential is held constant until the anodic linear sweep (or scan) begins, lasting for a time period, tₐ. As shown in FIG. 4, the current is changing under potentiostatic conditions during t_{c}, and the amplitude of I and the rate of the current change are sensitive only to the accelerator. The current is held constant in the scanning range, tₐ, to eliminate the interference of the suppressor on the accelerator measurement.

The anodic linear sweep may include sweeping from the open circuit potential, about 0 V, to a potential from about 1.5 V to about 1.6 V. Alternatively, the anodic linear sweep may include a potential plateau at potential from about 0.1 V to about 0.6 V to improve stripping and provide more precise Q_{c} data. The stripping peak area, A_{R}, which is the area under the curve corresponding to the linear sweep on the current versus time plot, is then used to estimate the concentration of accelerator present in the plating solution. The area under the stripping peak correlates to the charge required to oxidize the copper deposit, and is therefore proportional to the average deposition rate for that cycle, which reflects the accelerator concentration.

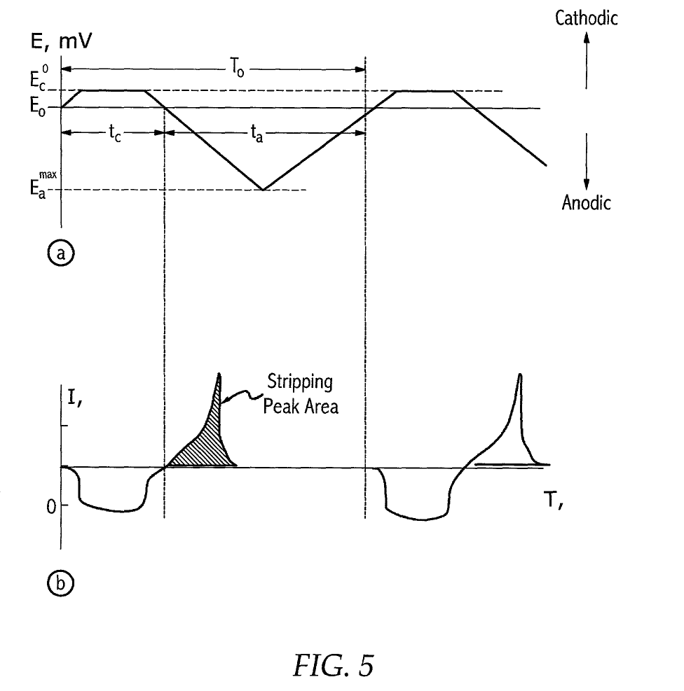

FIG. 5 illustrates the output of an exemplary embodiment of the invention. The method includes scanning for a period of time from the open circuit potential to reach a potential between about −0.25 V to about −0.4 V. The method then includes a plateau, i.e., a constant voltage, in the metal deposition region, t_{c}, until another cathodic scan to again reach the open circuit potential before the anodic linear sweep begins. By quickly scanning to a plateau and subsequently to the anodic linear sweep, the influence of the suppressor on the accelerator concentration is minimized.

Embodiments of the invention may estimate the accelerator concentration from the current response as a function of either the cathodic current increase at potentiostatic conditions when the potential E_{c}⁰ is between about −0.25 V and about −0.4 V, or as a function of Q_{c} or A_{R} in the same potential range. In this potential range, the current increase at E_{c}⁰ is a function of only the accelerator concentration and is dependent upon the suppressor concentration in a minimal range. The accelerator concentration may then be estimated from the initial current change at E_{c}⁰ near time t₀, i.e., the time when potentiostatic conditions begin.

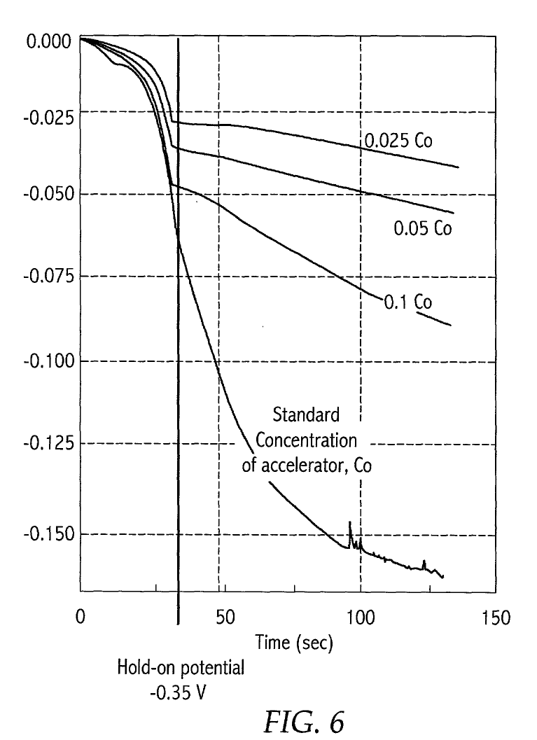

Embodiments of the invention further contemplate in-situ analysis of additive concentrations in plating solutions. In-situ or direct measurement analysis is time sensitive to the concentration data. Therefore, in-situ analysis minimizes unnecessary lag time between concentration analysis and correction of the additive concentration. During in-situ analysis, the concentration is measured not as a function of the stripping peak area, A_{R}, as in conventional CVS, but is based on current changes under potentiostatic cathodic pulse. Therefore, the current is a measure of only the accelerator, rather than other bath constituents, such as copper sulfate and sulfuric acid. FIG. 6 illustrates a typical cathodic current versus time for the potential signal of FIG. 3 at different concentrations of accelerators directly measured from the plating solution. The method gives the same response signal as embodiments discussed above, but the stripping step is used only for working electrode 202 surface refreshing, and not for analysis of the accelerator concentration. The current versus time curve at the potentiostatic regulation, i.e., E=E_{c}⁰, is changing so that:

(Iₜ₁−Iₜ₀)/(Iₜ₂−Iₜ₀)=[1−exp(−k_{c}t₁)]/[1−exp(−k_{c}t₂)]; (3)

where Iₜ₀ is the current at the beginning of the potentiostatic condition, Iₜ₁ and Iₜ₂ are the currents at arbitrary times t₁ and t₂. The constant, k_{c} may be determined from available rate date or calculated from the above equation.

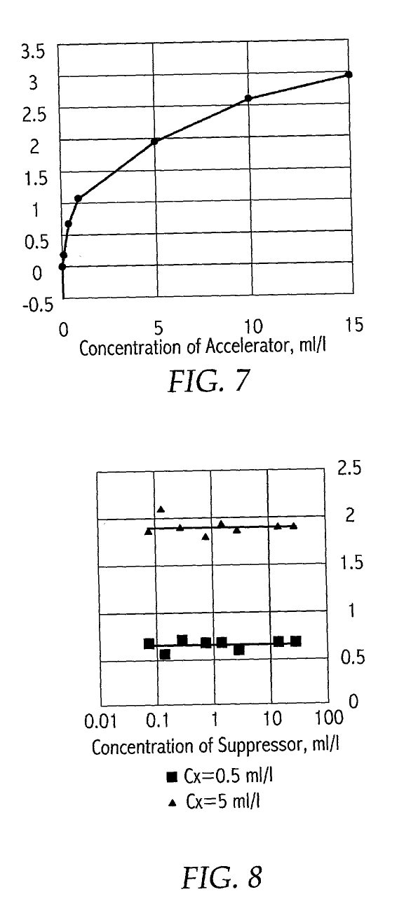

FIGS. 7 illustrates the accelerator current increase, dI/dt, as a function of time. The accelerator concentration may be estimated from the current response as a function of the current increase at potentionstatic conditions when the potential E_{c}⁰ is between about −0.25 V to about −0.4 V. In this range, the current increase at E_{c}⁰ is a function of only the accelerator concentration and is dependent upon the suppressor presence in a minimal range. The concentration may then be estimated from the initial current change at E_{c}⁰ close to t₀. The accelerator concentration may alternately be determined from the Iₜ₀ to Iₜ₂ difference and compared to available rate data. In addition, although the absolute current values, I, are sensitive to the concentration other components in the plating solution, such as copper ions, sulfuric acid, and chloride ions, the current change is nearly independent from the copper sulfate and sulfuric acid when the ratios of the actual copper sulfate concentration to the optimal copper sulfate concentration in the plating solution, CuSo₄/CuSO₄⁰, and the actual sulfuric acid concentration to the optimal sulfuric acid concentration in the plating solution, H₂SO₄/H₂SO₄⁰, are between about 0.8 and about 1.2.

FIG. 8 illustrates the suppressor current response, dI/dt, as a function of time. In contrast to FIG. 7 which illustrates the accelerator sensitivity to the IT signal changes, FIG. 8 illustrates the suppressor insensitivity to the IT signal changes for a wide window of suppressor concentrations, i.e., from about 0.1 mL/L to about 20 mL/L. Therefore, the suppressor concentration has no influence on the current change rate. However, even small changes in the accelerator concentration may cause increases or decreases in both dI/dt and Q_{c}.

Although described herein with reference to measuring the additive concentration in a plating solution, the above method may be used for measuring other additive concentrations in plating solutions. While the foregoing is directed to embodiments of the present invention, other and further embodiments of the invention may be devised without departing from the basic scope thereof, and the scope thereof is determined by the claims that follow.

What is claimed is:

1. A voltammetric method for measuring the concentration of additives in a plating solution, comprising:
cycling an inert working electrode potential through a metal deposition step and a metal stripping step, wherein the metal deposition step includes a constant voltage plateau at a plateau potential sufficient to eliminate the interference of additives in the plating solution other than an additive to be measured;
determining a profile of an anodic current resulting from the inert working electrode potential as a function of time and determining a stripping peak area; and
determining the concentration of the additive to be measured by a ratio of the stripping peak area from the profile of the anodic current to a stripping peak area of a base solution.

2. The method of claim 1, wherein the metal deposition step further includes pulsing to the plateau potential from an open circuit potential and pulsing back to an open circuit potential from the plateau potential before the metal stripping step.

3. The method of claim 1, wherein the metal stripping step comprises an anodic linear sweep.

4. The method of claim 1, wherein the metal deposition step further comprises scanning from an open circuit potential to the plateau potential and scanning back to the open circuit potential before the metal stripping step.

5. The method of claim 1, wherein the additive to be measured is an accelerator.

6. The method of claim 5, wherein the plateau potential is between about −0.25 V and about −0.4 V.

7. The method of claim 6, wherein the metal deposition step further comprises pulsing to the plateau potential from an open circuit potential and pulsing back to the open circuit potential from the plateau potential before the metal stripping step.

8. The method of claim 6, wherein the metal deposition step further comprises scanning from an open circuit potential to the plateau potential and scanning back to the open circuit potential before the metal stripping step.

9. The method of claim 5, wherein the metal stripping step comprises an anodic linear sweep from an open circuit potential to a potential of about 1.5 V to about 1.6V.

10. The method of claim 5, wherein the metal stripping step comprises a stripping potential plateau at a potential of from about 0.1 V to about 0.6V.

11. A voltammetric method for measuring the concentration of an accelerator in a plating solution, comprising:
cycling an inert working electrode potential through a metal deposition step and a metal stripping step, wherein the metal deposition step includes a constant voltage plateau at a potential of between about −0.25 V and about −0.4 V;
determining a profile of an anodic current resulting from the inert working electrode potential as a function of time;
determining a stripping peak area; and
determining a concentration of the accelerator by a ratio of the stripping peak area from the profile of the anodic current to a stripping peak area of a base solution.

12. The method of claim 11, wherein the metal deposition step further comprises pulsing to the plateau potential from an open circuit potential and pulsing back to the open circuit potential from the plateau potential before the metal stripping step.

13. The method of claim 11, wherein the metal stripping step comprises an anodic linear sweep.

14. The method of claim 11, wherein the metal deposition step further comprises scanning from an open circuit potential to the plateau potential and scanning back to the open circuit potential before the metal stripping step.

15. A voltammetric method for directly measuring the concentration of additives in a plating solution, comprising:
cycling an inert working electrode potential through a metal deposition step, wherein the metal deposition step comprises scanning to a constant voltage plateau at a plateau potential sufficient to eliminate the interference of additives in the plating solution other than an additive to be measured and scasnning back to an open circuit potential from the plateau potential before the metal stripping step;
cycling the inert working electrode potential through a metal stripping step, wherein the metal stripping step comprises an anodic linear sweep;
determining a profile of the anodic current response resulting from the applied inert working electrode potential as a function of time; and
determining the concentration of the additive to be measured by the anodic current response at the plateau potential.

16. The method of claim 15, wherein the metal stripping step further comprises an anodic linear sweep from the open circuit potential to a potential of about 1.5 V to about 1.6 V.

17. The method of claim 15, wherein the metal stripping step further comprises a stripping potential plateau between about 0.1 V and about 0.6 V.

18. The method of claim 15, wherein the metal deposition step further includes pulsing from an open circuit potential to the plateau potential and pulsing back to the open circuit potential before the metal stripping step.

19. The method of claim 15, wherein the additive to be measured is an accelerator.

20. The method of claim 19, wherein the plateau potential is between about −0.25 V and about −0.4 V.

21. The method of claim 20, wherein the metal deposition step further includes pulsing to the plateau potential from an open circuit potential and pulsing back to the open circuit potential from the plateau potential before the metal stripping step.

22. The method of claim 20, wherein the metal is copper.

23. The method of claim 15, wherein the step of determining the concentration of the additive further includes estimating the concentration from an initial current change.

24. The method of claim 15, wherein the step of determining the concentration of the additive further includes determining the concentration from a difference between an initial current and the current at a predetermined later time.

25. The method of claim 15, wherein the step of determining the concentration of the additive further includes determining the concentration from a constant, k_{c}.

26. The method of claim 15, wherein the plating solution further includes copper sulfate in a ratio to an optimum copper sulfate concentration of between about 0.8 to about 1.2.

27. The method of claim 15, wherein the plating solution further includes sulfuric acid in a ratio to an optimum sulfuric acid concentration of between about 0.8 to about 1.2.

28. A voltammetric method for directly measuring the concentration of an accelerator in a plating solution, comprising:
providing the plating solution to an electroplating cell, wherein the electroplating solution includes copper sulfate in a ratio to an optimum copper sulfate concentration of between about 0.8 and about 1.2, and sulfuric acid in a ratio to an optimum sulfuric acid concentration of between about 0.8 to about 1.2;
cycling an inert working electrode potential through a metal deposition step and a metal stripping step including an anodic linear sweep, wherein the metal deposition step includes pulsing to a constant voltage plateau at a plateau potential between about −0.25 V and about −0.4 V from an open circuit potential and pulsing back to the open circuit potential from the plateau potential before the metal stripping step;
determining a profile of the anodic current response resulting from the applied inert working electrode potential as a function of time; and
determining the concentration of the additive to be measured by a constant, k_{c} determined from the current response when the plateau potential is between about −0.25 V and about −0.4 V.

29. A voltammetric method for measuring the concentration of an accelerator in a copper plating solution, comprising:
cycling an inert working electrode potential through a metal deposition step and a metal stripping step, wherein the metal deposition step includes pulsing to a constant voltage potential from about −0.25 V to about −0.4 V from an open circuit potential and pulsing back to the open circuit potential before the metal stripping step, which comprises an anodic linear sweep;
determining a profile of the anodic current resulting from the applied inert working electrode potential as a function of time and determining a stripping peak area; and
determining the concentration of the accelerator by a ratio of the stripping peak area from the profile to a stripping peak area of a base solution not including the additive to be measured.
